(19) United States
(12) Patent Application Publication
(10) Pub. No.: US 2014/0071159 A1
(43) Pub. Date: Mar. 13, 2014

(54) Method and Apparatus For Providing a User Interface For a File System

(71) Applicants: Jianfei Ye, Richmond Hill (CA); Mir Ahsan, Toronto (CA); Chi Hing, Richmond Hill (CA); Jitesh Arora, Markham (CA)

(72) Inventors: Jianfei Ye, Richmond Hill (CA); Mir Ahsan, Toronto (CA); Chi Hing, Richmond Hill (CA); Jitesh Arora, Markham (CA)

(73) Assignee: ATI TECHNOLOGIES, ULC, Markham (CA)

(21) Appl. No.: 13/615,413

(22) Filed: Sep. 13, 2012

(51) Int. Cl. G09G 5/00

(52) U.S. Cl. 345/619

(57) ABSTRACT

A method and apparatus provides for controlling presentation of multimedia content. In one example, the method and apparatus changes a display perspective of a multimedia presenting system that presents the multimedia content by determining an amount of display perspective adjustment based on a relative position between a user and the multimedia presenting system. According to the determined amount of display perspective adjustment, the method and apparatus issues one or more control commands that instruct the multimedia presenting system to change the display perspective. The display perspective may be changed for example by moving a display or portion thereof and/or by changing the perspective of the displayed image on the display while leaving the position of the display alone.

### BACKGROUND OF THE DISCLOSURE

The disclosure relates generally to a method and apparatus for controlling presentation of multimedia content.

Presentation of multimedia content such as visual content (e.g. video, still image, animation, interactive graphics or any combination thereof) and if present, associated audiotypically provides users rich visual and/or auditory sensory experiences. With advancements in multimedia content presentation technologies, users are no longer limited to experiencing multimedia content through a device having a display and sound only ideal within confines of a small space. Today, sophisticated multimedia presenting systems are typically equipped with large display surfaces and sound systems capable of presenting multimedia content in large spaces, such as in a gymnasium or in a shopping plaza. These systems typically employ large display surfaces, either flat or curved, to display video, still image, animation, interactive graphics and other visual content. TV screen walls (e.g. LCD walls), supersized flat screens, 3D theater displays, large touchscreens, or projection screens are just some examples of such large display surfaces. Moreover, these systems are also typically capable of delivering audio output, for example, through multiple sound channels to create a dynamic sound environment for an enhanced sound experience.

A user experience in perceiving multimedia content presented by a multimedia presenting system is typically at best when the audio and the visual of the multimedia content are delivered to the user with a proper display perspective (e.g. size, screen location, etc) and audio output level. For a particular distance and viewing angle between the user and multimedia presenting media system, there is typically an optimal display perspective and audio output level for the user to satisfactorily perceive the multimedia content. Accordingly, for different user locations (e.g. distance and/or viewing angle) relative to the multimedia presenting system, the optimal display perspective and audio output level can change. However, conventionally, multimedia content is typically presented with a predetermined display perspective and audio output level. Under the conventional presenting method, such a display perspective and audio output level do not change as the user's location relative to the multimedia system changes. As a result, the relative position of a user with respect to the multimedia system can impact user's multimedia experience to various degrees when the user is outside the optimal viewing area created by the predetermined display perspective and audio output level.

When displaying commercial multimedia advertisements on a TV wall in a shopping plaza under the conventional approach for an example: the display size and other aspects of the display perspective for the product displayed on the TV wall are predetermined and do not change based on the user's location relative to the TV wall. If a user is too far away from the TV wall, the product as displayed on the TV wall may be too small for the user to comprehend. On the other hand, the product as displayed on the TV wall may be too big and overwhelming for the user if the user is too close to the TV wall. The same dilemma remains for audio output level of the advertisement as well. In these situations, the advertisement will lose its intended effects due to a non-optimal rigid presentation insensitive to the user location.

Some known techniques are directed to solve the above-noted problems. In an obvious solution, a user can manually adjust a display perspective and/or audio output level of a multimedia system whenever the user moves around in the space covered by the multimedia presenting system. However, in many circumstances, this solution is difficult to achieve due to form factors and other physical restraints of the multimedia presenting system. For instance, for large systems like a TV wall or a large stadium display screen, it is difficult for a user to control and adjust the display perspective of the multimedia presentation system. Even if when such an adjustment is possible, e.g. the multimedia presenting system has a swivel that allows the display housing orientation to be adjusted, it still may be too cumbersome and thus impractical for the user to manually adjust the display perspective and/or audio output level of the multimedia presenting system whenever his/her position relative to the multimedia presentation system changes.

As an improvement, many multimedia presenting systems provide capability to allow a user to change a display perspective of the multimedia presenting system through a remote control device. For example, the user may use the remote control device to change screen location of one or more display surfaces of the multimedia presenting system. Under this solution, the user determines a preferred display perspective based on his/her position relative to the multimedia presenting system and issues commands accordingly, e.g. moving the screen up, down, left, and/or right, via the remote control to effect the desired display perspective adjustment. However, to achieve a desired adjustment, the user must know the multimedia presenting system's capability to change a display perspective. In addition, this solution also requires the user to know how to adjust a display perspective of the multimedia presenting system, i.e. what commands to issue to change a display perspective. For many sophisticated multimedia presenting systems, their capabilities to change a display perspective of the multimedia presenting system are not obvious for a user to grasp without in-depth knowledge of the multimedia presenting system. Most users of a multimedia presenting system, e.g. customers in a shopping mall, are typically not equipped with such knowledge and may obtain such knowledge only by reading an operation manual of the multimedia presenting system. Thus this solution adds inconvenience and extra learning to the user.

In yet another solution, increasing the number and size of display surfaces, e.g. LCD screens, can enlarge viewing areas such that a user may satisfactorily perceive the multimedia content from different locations. For example, many sports bars employ multiple screens at different locations to accommodate different viewing angles of their patrons. However increasing the number and/or size of display surfaces employed by a multimedia presenting system adds costs and may not be economical when most of the display surfaces are not used most of the time.

Accordingly, for one or more of the above-noted problems, there exists a need for an improved method and apparatus for controlling the presentation of multimedia content.

### BRIEFED DESCRIPTION OF THE DRAWING

The embodiments will be more readily understood in view of the following description when accompanied by the below figures and wherein like reference numerals represent like elements, wherein:

FIG. 1 is a block diagram illustrating one example of an apparatus for controlling presentation of multimedia content in accordance with one embodiment set forth in the disclosure;

FIG. 2 is a block diagram illustrating the apparatus for controlling presentation of multimedia content shown in FIG. 1;

FIG. 3 is a flowchart illustrating one example of a method for controlling presentation of multimedia content;

FIG. 4 is a flowchart illustrating another example of a method for controlling presentation of multimedia content;

FIG. 5 is a flowchart illustrating still another example of a method for controlling presentation of multimedia content; and

FIGS. 6-8 are exemplary illustrations of controlling presentation of multimedia content

### DETAILED DESCRIPTION OF EMBODIMENT(S)

Briefly, in one example, a method and apparatus controls presentation of multimedia content, such as an image (still and/or video), text, animation, interactive graphics, associated audio or any combination thereof, by changing a display perspective of a multimedia presenting system based on data indicating a relative position between a user and the multimedia presenting system. The multimedia presenting system may be any suitable apparatus that employs one or more display surfaces and is operative to display, such as but not limited to images, text, animation, and/or interactive graphics, on the display surfaces. The type of display surface employed by the multimedia presenting system may include, but is not limited to, liquid crystal displays (LCD), light-emitting diode (LED) displays, organic LED (OLED) displays, cathode ray tube (CRT) displays, plasma displays, projector screens, electroluminescent displays, vacuum fluorescent (VF) displays, laser displays, E-ink displays, and any other suitable medium operative to display an image. A display perspective of a multimedia presenting system may include, but is not limited to, the orientation, size, color, contrast, brightness, or any other display aspects of the visual content displayed on the display surfaces of the multimedia presentation system, the screen location of the display surfaces, and the housing orientation of the display surfaces, just to name a few as examples. As the user's position with respect to the multimedia presenting system changes, the method and apparatus automatically changes a display perspective of the multimedia presenting system accordingly such that the user's perception of the multimedia content displayed on the display surfaces of the multimedia presenting system remains optimal.

Among other advantages, for example, the method and apparatus may provide, in one example, the ability to automatically change the display perspective of the multimedia presenting system based on the user's position relative to the multimedia presenting system without the user's intervention. Instead of requiring the user to determine his/her position relative to the multimedia presenting system, to determine an display perspective adjustment based on this relative position and to carry out the adjustment by manually changing the display perspective of the multimedia presenting system, the disclosed method and apparatus automatically changes the display perspective of the multimedia presenting system for the user based on the user's location relative to multimedia presenting system without the user's invention. Further, the method and apparatus may also intelligently determine the amount of adjustment of the display perspective based on information indicating the multimedia presenting system's, for example but not limited to, status and/or capability to change a display perspective. The method and apparatus, thus, provides a user an enhanced multimedia experience without inconveniencing the user to change the display perspective of the multimedia presenting system manually as the user changes his/her location with respect to the multimedia presenting system. For example, a presenter such as an advertiser may wish to utilize the method and apparatus to automatically adjust a display perspective of the advertised product displayed on the display surfaces of the multimedia media system as the user moves around the multimedia presenting system so to provide the user an enhanced multimedia experience of the advertised product presented by the multimedia media system.

The method and apparatus may also change audio properties of the multimedia presenting system based on a relative position between the user and multimedia presenting system. The audio properties include, but not limited to, at least audio volume of the multimedia presenting system.

In one example, the method and apparatus changes the display perspective and/or audio properties of the multimedia presenting system based on the display perspective changing capability, status, or any other relevant information regarding the multimedia presenting system. The method and apparatus may obtain such information, for example, from a lookup table in a file or database, via an operation that queries the multimedia presenting system for such information at a desired frequency. Alternatively, the method and apparatus may also obtain such information from an operation that pushes such information at a desired frequency from a source, e.g. a database. The information regarding the multimedia presenting system that can facilitate the method and apparatus to change a display perspective may include, but not limited to, status, one or more capabilities to change a display perspective and the current display perspective of the multimedia presenting system. In response to the obtaining of the information regarding the multimedia presenting system, the method and apparatus may change a display perspective of the multimedia presenting system based on such information.

In one example, the method and apparatus may also receive configuration information to change a display perspective of the multimedia presenting system. The method and apparatus may obtain receive such configuration information, for example, from an administrative control during configuration stage or during operation stage of the multimedia presenting system. In response to the obtaining of the configuration information, the method and apparatus may then change a display perspective of the multimedia presenting system based on the configuration information.

In one example, in addition to changing a display perspective and/or audio properties of the multimedia presenting system, the method and apparatus may also determine a relative position between a user and the multimedia presenting system. This relative position may be determined by comparing the user's location information to the location of the multimedia presenting system. The user location information may comprise data obtained from a least one location detection device, for example such as, one or more GPS receivers, infrared sensors, cameras, wireless receivers, radio signal receivers, cellular phone signal receivers or any other suitable signal sensors or receivers operative to receive signals indicating a location of the user. In addition, the information indicating the user's location and/or the multimedia presenting system's location may also be obtained from a remote source, for example such as, remote server, data center, control station, and cellular tower, to name a few.

In one example, changing the display perspective of the multimedia presenting system may include determining an amount of a display perspective to be adjusted based on a relative position between a user and a multimedia presenting system. The method and apparatus may determine such an amount of adjustment by determining a geographical relationship between the user and the multimedia presenting system, for example, the distance between the user and the multimedia presenting system. Based on this geographical relationship, the method and apparatus may then determine the amount of adjustment for the display perspective employed by the multimedia presenting system. The display perspective adjustment may include, but not limited to, adjusting display angle, size, resolution, screen location, brightness, color, and any other display aspects of the multimedia content displayed on the display surface of the multimedia presenting system. According to the determined amount of the display perspective to be adjusted, the apparatus and method may issue one or more control commands instructing the multimedia presenting system to effect the determined display perspective adjustment.

In another example, the method and apparatus may change the display perspective of a multimedia presenting system to match detected eye level of a user. When the user is moving around, the method and apparatus may adjust the display perspective as the user's position changes. For instance, when the user is sitting down, the method and apparatus may change the display perspective of the multimedia presenting system by re-positioning the screen location of one or more display surfaces of the multimedia presenting system, e.g. projection screen, such that the display of multimedia content will match the user's eye level. Accordingly, apparatus and method may detect the user's presence by using one or more location detection devices. The method and apparatus then detects an eye level of the user with respect to the multimedia presenting system. Based on the detected user's eye level, the apparatus and method changes the display perspective of the multimedia presenting system to match the user's eye level.

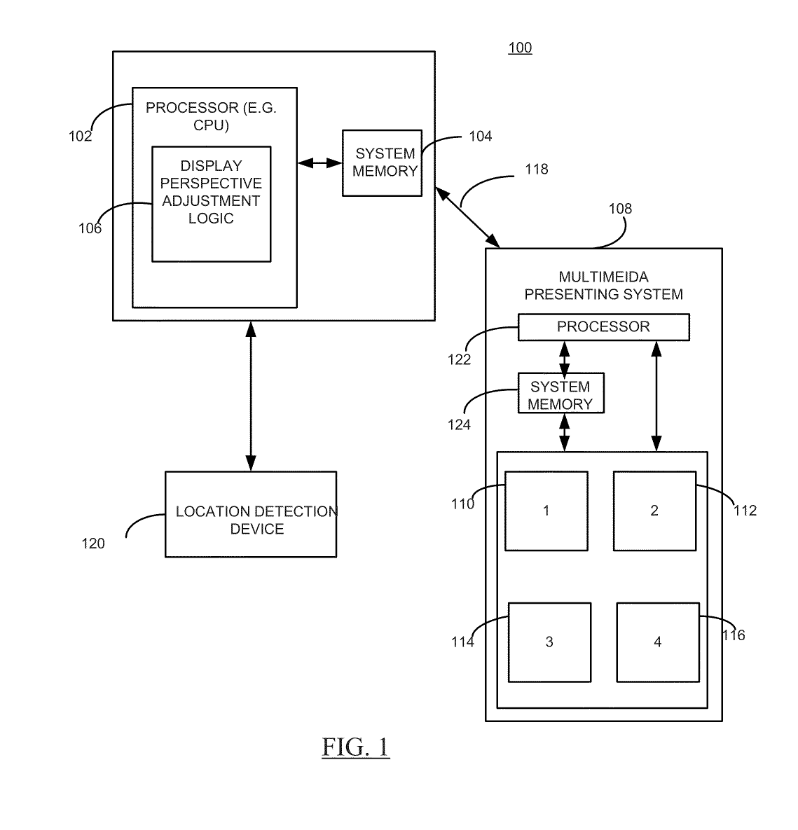

FIG. 1 illustrates one example of an apparatus 100 for controlling presentation of multimedia content. The apparatus 100 may be any suitable device, for example, a media center, a set top box, television, laptop computer, desktop computer, handheld device(e.g. mobile or smart phone, tablet), or any other suitable device, to name a few. In this example, the apparatus 100, employs at least one processor 102, operatively connected to a system memory 104. The apparatus 100 may include a multimedia presenting system 108, for example, a system that can present multimedia content on one or more display surfaces within the system and as well as execute control commands to change a display perspective of the system. The apparatus 100 may also include a location detection device 120, such as an infrared sensor, ultra sound sensor, GPS receiver, radio signal receiver, satellite signal receiver, wired or wireless network interface card, cameras, or any other suitable device. Any other suitable structure, such as but not limited to a storage device or a controller, may also be included in the apparatus 100.

In this example, the processor 102 is a central processing unit (CPU) having multiple cores however any suitable processor may be employed including a DSP, APU, GPGPU or any suitable processor or logic circuitry. In this example, the processor 102 is bi-directionally connected to system memory 104 as known in the art. In this example, the apparatus 100 further includes a multimedia presenting system 108. The processor may operatively connect to the multimedia presenting system 108 via a suitable connection 118, for example such as, a bus, connector, infrared, wireless link, and etc. It is understood that although one multimedia presenting system 108 is illustrated in FIG. 1, one or more multimedia presenting systems may be included in or connected to the apparatus 100. The connection 118 may be internal to the apparatus 100 and the multimedia presenting system 108 may form a part of the apparatus 100—e.g., a presentation forming part of the apparatus 100, such as, for example, a multimedia system operative to present multimedia content and as well as adjust a display perspective of the multimedia presenting system 108 automatically based on the user's location. In other examples, the multimedia presenting system 108 may be remote to the apparatus 100 and is operatively coupled to the apparatus 100 via networks (e.g. personal area network, local area network, wide area network, etc.) or any suitable wired or wireless connections as known in the art. It is understood that, although only one apparatus 100 is shown in FIG. 1, multiple apparatus may be applied to employ the multimedia presenting system 108.

In this example, the processor 102, when executing code stored in memory, employs display perspective adjustment logic 106 configured to change a display perspective of a multimedia presenting system, e.g. the multimedia presenting system 108, based on a relative position between a user and the multimedia presenting system. The display perspective adjustment logic 106 referred to herein is any suitable executing software module, hardware, executing firmware or any suitable combination thereof that can perform the desired function, such as programmed processors, discrete logic, for example, state machine, to name a few. It is understood that the display perspective adjustment logic 106 may be included in the processor 102 as part of the processor 102, or a discrete component of the apparatus 100 that can be executed by the processor 102, such as software programs stored on computer readable storage medium that can be loaded into the apparatus 100 and executed by the processor 102. The display perspective adjustment logic 106 may communicate with structures in the apparatus 100 such as but not limited to the location detection device 120, the system memory 104, and the multimedia presenting system 108. The display perspective adjustment logic 106 may also communicate with software programs running on the processor 102, for example, the OS, file manager, system database, etc. It will be recognized that instead of a processor, an FPGA, ASIC, state machines or other suitable logic may be employed.

As illustrated, in this example, the multimedia presenting system 108 includes a processor 122, a system memory 124, and a plurality of displays 110, 112, 114, 116. It is understood that the number of the displays that a multimedia presenting system includes may be varied. The displays 110, 112, 114, 116 may be any suitable physical displays known in the art, such as but not limited to liquid crystal displays (LCD), light-emitting diode (LED) displays, organic LED (OLED) displays, cathode ray tube (CRT) displays, plasma displays, projector screens or surfaces, electroluminescent displays, vacuum fluorescent (VF) displays, laser displays, E-ink displays or any other suitable displays to name a few. The displays 110, 112, 114, 116 may be arranged in a homogenous manner so that all the displays 110, 112, 114, 116 are the same type. The displays 110, 112, 114, 116 may also be arranged in heterogeneous manner. For example, the first, second, and third displays 110, 112, 114 may be LCD displays and the fourth display 116 may be a CRT display. One or more displays 110, 112, 114, 116 may form a continuous display surface that produces image (still and/or video), text, animation, interactive graphics or any other suitable graphical content, for example such as, a TV screen wall. One or more displays 110, 112, 114, 116 may also form different discrete display surfaces, such as, for example, four different LCD screens placed at different display locations.

In this example, the multimedia system 108 also includes a processor 122 operative to execute one or more control command to change a display perspective of one or more display surfaces of the multimedia presenting system 108, e.g. the displays 110, 112, 114, 116. Also as illustrated, the processor 122 is operatively connected a system memory 124 residing on the multimedia presenting system 108. It is understood although the processor 122 and system memory 124 are shown as residing outside the displays 110, 112, 114, 116, they may be part of the display in some other examples to form smart displays within the multimedia presenting system 108. It is also understood the multimedia presenting system 108 and its member displays may employ any number of processors or system memory. It is further understood in embodiments where the apparatus 100 includes multimedia presenting system 108, the processor 122 and processor 102 may be combined to form a general processor. Likewise, in those embodiments, the system memory 124 and 104 may be combined. Any other suitable structure, such as but not limited to a storage device or a controller, may also be included in the multimedia presenting system 108.

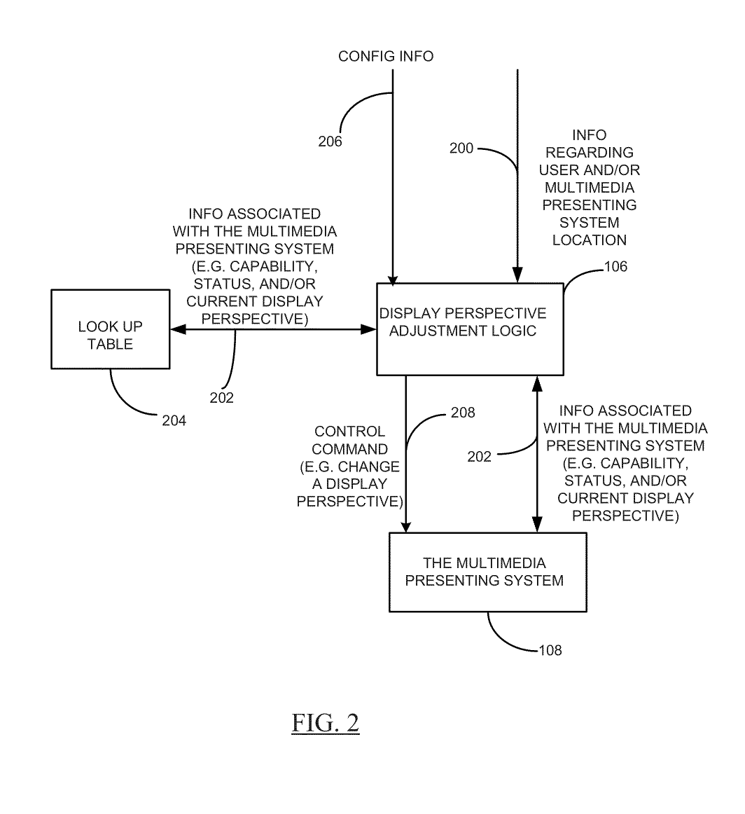

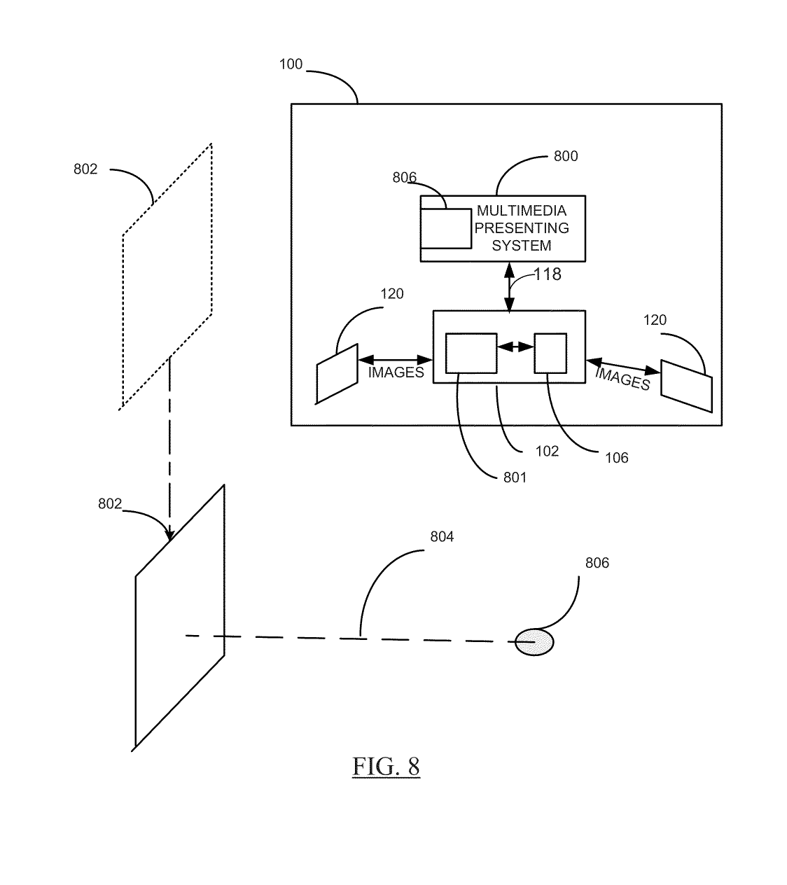

FIG. 2 illustrates one example of an apparatus for controlling presentation of multimedia content. The apparatus 100 includes the display adjustment logic 106. The display adjustment logic 106 is operative to receive information 200 indicating location of a user and/or the multimedia presenting system 108. The location information 200 may comprise data indicating, for example, such as but not limited to, X, Y and/or Z coordinates, latitude, longitude and/or altitude, distance. The location information 200 may also comprise one or more pictures through which relevant location data of a user and/or the multimedia presenting system may be obtained. The location information 200 may also include data that readily indicates a relative position between the user and the multimedia presenting system 108, e.g. (X, Y, Z) coordinates of a user location with respect to the multimedia presenting system 108 in a 3-D coordinate system, wherein the multimedia presenting system 108 is the origin of the 3-D coordinate system. The display adjustment logic 106 may receive location information 200 from a location detection device, such as the location detection device 120, which is not shown in FIG. 2. Examples of location detection device 120 are described in detail later referring to FIG. 8. The display adjustment logic 106 may also receive location information 200 from a remote source, such as but not limited to, a cellular tower, computer server, database, and control station, just to name a few.

The display perspective adjustment logic 106 may also be operative to receive information 202 regarding the multimedia presenting system 108. The information 202 may include data indicating the status, one or more capabilities, a current display perspective of the multimedia presenting system 108, and/or any other relevant aspects pertinent to the display perspective of the multimedia presenting system 108. The information 202 may be received from a lookup table 204. The lookup table 204 may be a dedicated file kept in a storage device, such as the system memory 104, or a database operatively coupled to the processor 102. It is understood that the lookup table 204 may be updated at any desired frequency. It is also understood, although only one lookup table 204 is shown, the display perspective adjustment logic 106 may receive information 202 from any number of lookup tables.

Each type of the information 202 may also be received from the multimedia presenting system 108 through a query operation performed by the processor 102 or a push operation performed by the multimedia presenting system 108. For example, the processor 102 may initiate a query to the multimedia presenting system 108 to poll the information 202 from the multimedia presenting system 108 at any desired point of time. In another example, the multimedia presenting system 108 may execute commands on its processor 122 to push the information 202 to the processor 102 at a desired frequency. The processor 102 may keep the received information 202 in a storage device operatively coupled to the processor 102, e.g. the system memory 104. The display perspective adjustment logic 106 may then retrieve the information 202 from the storage device at a desired point of time in order to change a display perspective of the multimedia presenting system 108.

The information 202 may include information regarding the status of a multimedia presenting system, e.g. the multimedia presenting system 108. The status of a multimedia presenting system may include but is not limited to information indicating one or more displays within the multimedia presenting system 108 are offline or online, and the running mode (e.g. displaying, stand-by, hibernate) of each online display. For example, the information 202 may indicate that display 110 is offline, displays 112, 114, 116 are online. Further, the information 202 may indicate the display 112 is powered-off, display 114 is powered-on displaying, and display 116 is stand-by. It is understood that the above-mentioned status of a multimedia presenting system is presented for the purpose of exemplary description only and not by limitation.

The information 202 may also include information (i.e., data) regarding a current display perspective of a multimedia presenting system. For example, the information 202 may indicate that multimedia content are currently being displayed on one or more member displays, e.g. displays 110, 112, 114, 116, by a multimedia presenting system, e.g. the multimedia presenting system 108. The information 202 may also indicate the screen location of one or more displays within a multimedia presenting system 108 that are currently displaying the visual of the multimedia content, e.g. display 110 is located (x, y, z) location in a 3-D space. The information 202 may further indicate the size and/or resolution of the visual content being displayed on one or more displays within a multimedia presenting system 108. The information 202 also can indicate one or more displays' position and/or orientation within a multimedia presenting system 108. It is understood that the above-mentioned information 202 regarding a multimedia presenting system is presented for the purpose of exemplary description only and not by limitation.

Another type of information 202 is information regarding one or more capabilities of a multimedia presenting system to change a display perspective. Such capabilities may include a multimedia presenting system's, e.g. the multimedia presenting system 108, capability to move a display housing orientation of the multimedia presenting system. For example, displays 110, 112 of the multimedia presenting system 108 may be equipped with motorized swivels such that the motorized swivel may rotate displays 110, 112, for a first number degrees in a horizontal direction and/or for a second number of degrees in a vertical direction, or move displays 110, 112 for a small distance in horizontal and/or vertical direction. Such capabilities may also include a multimedia presenting system's capability to resize the image (still and/or video) displayed on the display surfaces, i.e. displays 110, 112, 114 116 of the multimedia presenting system 108. For example, the multimedia presenting system 108 may be operative to scale, i.e. upscale or downscale, multimedia content being displayed by the multimedia presenting system 108 on one or more displays 110, 112, 114, 116 to a different resolution from the current resolution. In another example, the multimedia presenting system 108 may also be operative to zoom in on or zoom out of multimedia content, e.g. an image (still or video), displayed on one or more displays within the multimedia presenting system 108.

The capabilities of a multimedia presenting system conveyed by the information 202 may also include the multimedia presenting system's capability to adjust placement of multimedia content displayed by the multimedia presenting system 108, such as but not limited to, the capability to change screen position, display orientation, and/or change the display angles of one or more displays of the multimedia presenting system 108, to name a few. For example, the multimedia presenting system 108 may be operative to adjust the screen position, i.e. up, down, left and right, of on one or more displays 110, 112, 114, 116. In another example, the multimedia presenting system 108 may also be operative to move the screen location of one or more displays 110, 112, 114, 116—e.g. floating projected image and/or video to a different projector screen or surface or switching image and/or video being displayed on one display to a different display. In some other examples, the multimedia presenting system 108 may be operative to change the display angle of image and/or video displayed on one or displays 110, 112, 114, 116 to effect a variation of depth perception. The capability of the multimedia presenting system 108 may also include adjusting display size, contrast, brightness, color and any other suitable display perspective aspects of one or more displays within the multimedia presenting system 108. It is understood that the above-mentioned capabilities of a multimedia presenting system is presented for the purpose of exemplary and description only and not by limitation. Any suitable capability of a multimedia presenting system to change a display perspective may be appreciated by those having ordinary skill in the art.

The information 202 may also include information indicating positions of one or more displays (e.g. displays 110, 112, 114, 116) within a multimedia presenting system (e.g. the multimedia presenting system 108). For example the information 202 may indicate that display 110 is at a position with X and Y coordinates with respect to the center of the multimedia presenting system.

In this example, the display perspective adjustment logic 106 may also receive configuration information 206, for example, from an administrative control. The configuration information 206 may contain number of predetermined ways the display perspective logic 106 may change a display perspective of the multimedia presenting system 108. For example, the configuration information 206 may configure the display perspective logic 106 to change housing orientation of the multimedia presenting system 108 and change placement of image (still and/or video) displayed by the multimedia presenting system 108 but not to change the size or resolution of the multimedia content. The configuration information 206 may also configure the display perspective logic 106 to change the display perspective of displays 110, 112 according to their capabilities indicated by the information 202 but not to change display perspective 114 and 116 at all. The configuration information 206 may also include the order of the preferences of changing a display perspective of the multimedia presenting system 108, e.g. prefer changing the display housing orientation of the multimedia presenting system 108 to adjusting placement of media content displayed by the multimedia presenting system 108.

In this example, the display perspective adjustment logic 106 is further operative to issue at least one control command 208 that changes a display perspective of the multimedia presenting system 108 according to an determined amount of display perspective adjustment base on the location information 200, the information 202 and/or the configuration information 208. The control command 208 may be, for example but not limited to, “rotating housing orientation of display 110 horizontally by −15 degrees and by +20 degrees vertically”, “moving the display 114 horizontally by 20 center meters to the right using the swivel”, “upscale the video displayed on the display 116 to a resolution of 19200×12840 pixels”, “switching image and/or video being displayed on display 112 to display 114”, “moving the screen position of display 116 upwards by 50 center meters”, “floating the projection to the ceiling”, and any combination thereof, just to name a few. It is understood that the above-mentioned control commands the display perspective adjustment logic 106 may issue to change a display perspective of the multimedia presenting system 108 are presented for the purpose of exemplary and description only and not by limitation. Any suitable control command or control commands to change a display perspective may be appreciated by those having ordinary skill in the art.

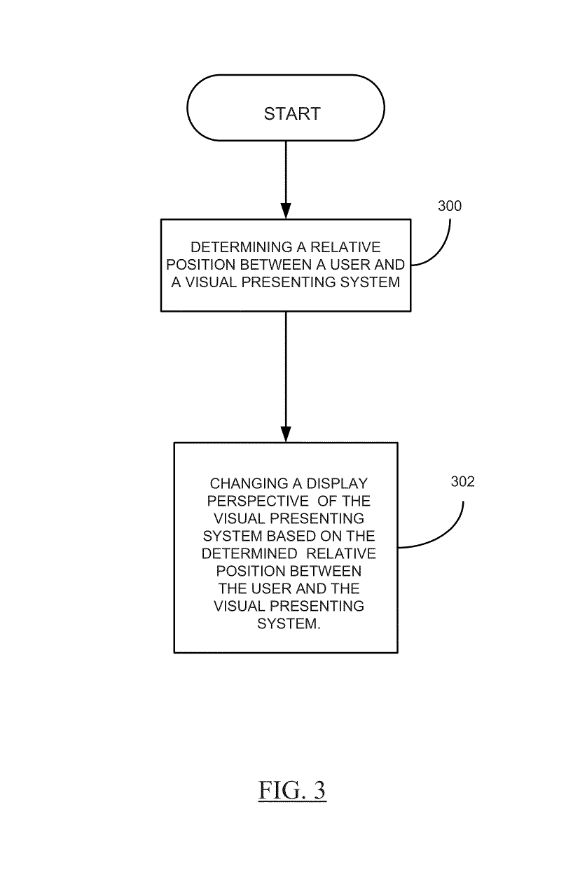

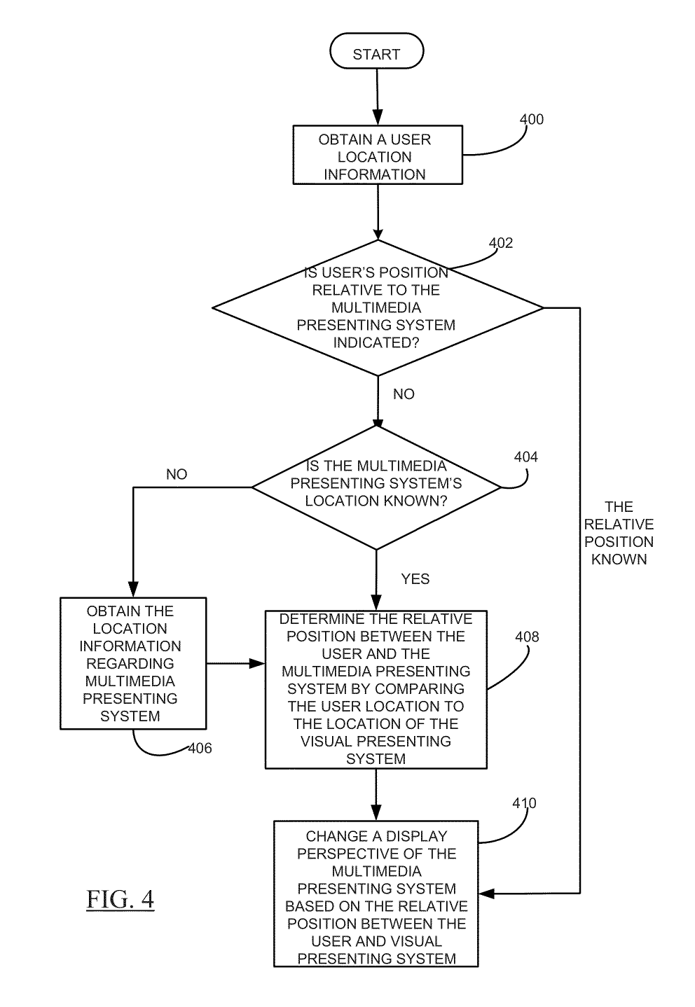

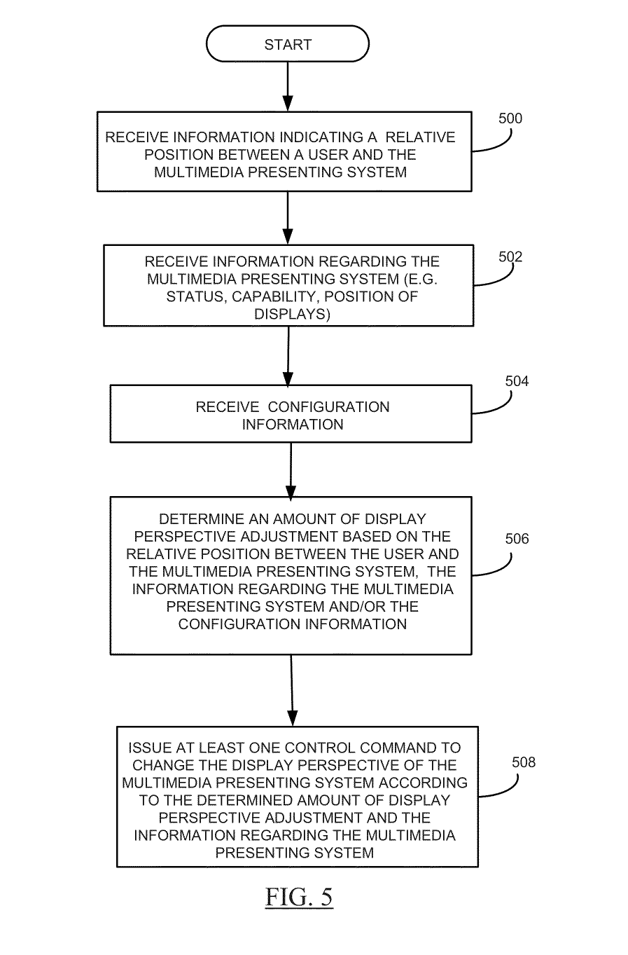

FIG. 3 illustrates one example of a method for controlling a presentation of multimedia content. It will be described with a reference to FIGS. 1 and 2. However, any suitable structure may be employed. In operation, at block 300, the display perspective adjustment logic 106 determines a relative position between a user and the multimedia presenting system. At block 302, the display perspective adjustment logic then changes the display perspective of the multimedia presenting system based on the determined relative position between the user and the multimedia presenting system. The blocks 302 and 304 are further illustrated in FIGS. 4 and 5. It is understood that in other examples block 302 may be omitted in the processing, i.e. a relative position between the user and the multimedia presenting system 108 may be received without being determined by the display perspective adjustment logic 106.

Referring to FIG. 4, in this example embodiment, the method of controlling presentation of multimedia content may include obtaining the user location information 200 from one or more location detection devices. Alternatively, as noted above, the user location information 200 may be obtained from a remote source, such as but not limited to, cellular tower, remote computer server, or a control station, to name a few. At block 402, in operation, the display perspective adjustment logic 106 recognizes whether the obtained user location information 200 indicates a relative position between the user and multimedia presenting system 108. In some examples, such a relative position, e.g. the distance, direction, and/or the angle between the user and multimedia presenting system is indicated by the user location information 200, i.e. the user location information 200 is in a form that readily represents the user location with respect to the multimedia presenting system 108 in the same coordinate system. In one embodiment in accordance with the disclosure, the user location information 200 may, however, not indicate a relative position between the user and the multimedia presenting system 108. For example, the user location information 200 may only indicate a latitude and longitude of a user's location. In that case, the display perspective adjustment logic 106 recognizes that a relative position between the user and the multimedia presenting system 108 is not indicated by the user location information 200 and proceeds to block 404. At block 404, in operation, the display perspective adjustment logic 106 recognizes whether the location of the multimedia presenting system 108. In one embodiment in accordance of the disclosure, it is recognized that the location of the multimedia presenting system 108 is not known, the process proceeds to block 406. At block 406, the display perspective adjustment logic obtains the location information of the multimedia presenting system 108. As noted above, the location information of the multimedia presenting system 108 can be obtained from one or more location detection devices, e.g. the location detection device 120, a pre-compiled lookup table such as the lookup table 210 or directly from the multimedia presenting system either through a query or push operation.

Proceeding to block 408, the display perspective adjustment logic 106 determines a relative position between the user and the multimedia presenting system 108 by comparing the user's location to the location of the multimedia presenting system 108. For example, it may be determined that the user is on the right side of the multimedia presenting system 108 by comparing the X and Y coordinates of the user location to the X and Y coordinates of the multimedia presenting system 108's location. In another example, a distance between the user and multimedia presenting system 108 may be determined based on the X, Y and Z coordinates of the user and the multimedia presenting system 108's location. In yet another example, an angle between the user and the multimedia presenting system 108 may be determined based on the X, Y, and Z coordinates of the user location and the location of the multimedia presenting system 108. In some other examples, an eye level of the user with respect to the multimedia presenting system 108, e.g. the user's eye level is 30 degree below one or more display surfaces of the multimedia presenting system 108, may be determined. Examples of determining an eye level of a user with respect to the multimedia presenting system 108 are described in detail later referring to FIG. 8. At block 410, in operation, the display perspective adjustment logic 106, having obtained the information indicating a relative position between the user and the multimedia presenting system, may then change a display perspective of the multimedia presenting system 108 based on such a relative position.

Referring to FIG. 5, in this example embodiment, the method for controlling presentation of multimedia content may include receiving the location information 200 indicating a relative position between a user and the multimedia presenting system 108 at block 500. As noted above, the location information 200 includes information indicating a user location and/or a multimedia presenting system's location. Information indicating a multimedia presenting system's location may be included in location information 200, for example, when the multimedia presenting system 108 is remote to the processor 102. At block 502, preferably, the method includes receiving information 202 regarding the multimedia presenting system 108, such as its status and one or more capabilities to change a display perspective, and/or a current display perspective of the multimedia presenting system 108, as described above. At block 504, the configuration information 206 that configures the display perspective logic 106 as described above may also be received. It is understood that in other examples, blocks 502 and 504 may be omitted in the processing and the configuration information 206 may be predefined rules without being input by an administrative control.

At block 506, the display perspective adjustment logic 106 determines an amount of display perspective adjustment based on the relative position between the user and the multimedia presenting system 108, the information 202 regarding the multimedia presenting system 108 and, optionally, the configuration information 206. At block 508, in operation, the display perspective adjustment logic 106 issues at least one control command to change the display perspective of the multimedia presenting system 108 according to the determined amount of display perspective adjustment.

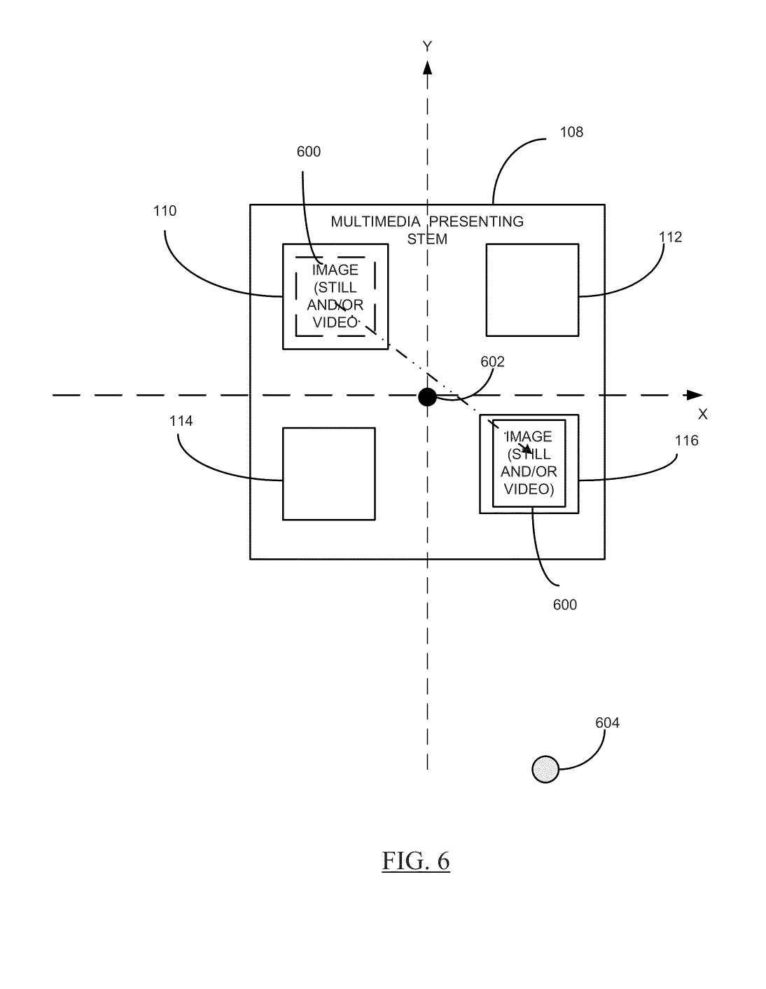

FIGS. 6-8 are illustrations of exemplary embodiments in accordance with the disclosure. FIG. 6 illustrates an example controlling presentation of multimedia content by changing the placement of image (still and video) 600 of the multimedia content from an original display (i.e. the first display 110) to a destination display (i.e. display 116) based on the determined relative position between the user 604 and a multimedia presenting system (e.g. the multimedia presenting system 108). In this example, the multimedia presenting system 108 displayed the image (still and/or video) 600 on display 110 while displays 112, 114, 116 were not displaying the image 600 before receiving information regarding a relative position between the user 604 and the multimedia presenting system 108. The status for each display is as follows: display 110 is online and displaying image (still and/or video) 600; display 112 is offline, display 114 and 116 are online and standby.

In this example, the display perspective adjustment logic 106 receives information 200 indicating a position of a user 604 relative to the multimedia presenting system 108. The display perspective adjustment logic 106 determines that the user 604 is on the right side of the multimedia presenting system 108 relative to the center 602 of the multimedia presenting system 108. The display perspective adjustment logic 106 may also receive information 202 regarding the status, capabilities, a current display perspective, or any other relevant display perspective information of the multimedia presenting system 108. In this example, the information 202 indicates that the multimedia presenting system 108 is displaying the image (still and/or video) 600 of the multimedia content only on display 110. The information 202 also indicates that displays 112 and 116 are on the right side of the multimedia presenting system 108. Further, the information 202 also indicates that the multimedia presenting system 108 is capable of waking up display 116 from the standby mode and switching the image (still and/or video) 600 from being displayed on display 110 to display 116. However, the information 202 also indicates display 114, although is on the right side of the multimedia presenting system 108, is offline and thus not available to display the image 600. Based on the determined relative position and the information 202 regarding the multimedia presenting system 108, the display perspective adjustment logic 106 determines that the image 600 should be displayed on displays that are on the right side of the multimedia presenting system 108, and thus on display 116, to give the user 604 an optimal viewing experience.

Accordingly, the display perspective adjustment logic 106 issues a first control command that will wake up the display 116 from the stand-by mode, a second control command that instructs the multimedia presenting system 108 to display image 600 on display 116, and optionally, a third control command that instructs the multimedia presenting system 108 not to continue to display image 600 on display 110 by switching the display 110 to the stand-by mode. It is understood that although four discrete displays are illustrated for changing placement of image 600 in this example, one of ordinary skill in the art will appreciate that the four discrete displays can be combined into one continuous display surface and the placement of image 600 can be changed by moving the screen location within the combined continuous display surface (e.g. move the screen location from top left to the bottom right of the display surface).

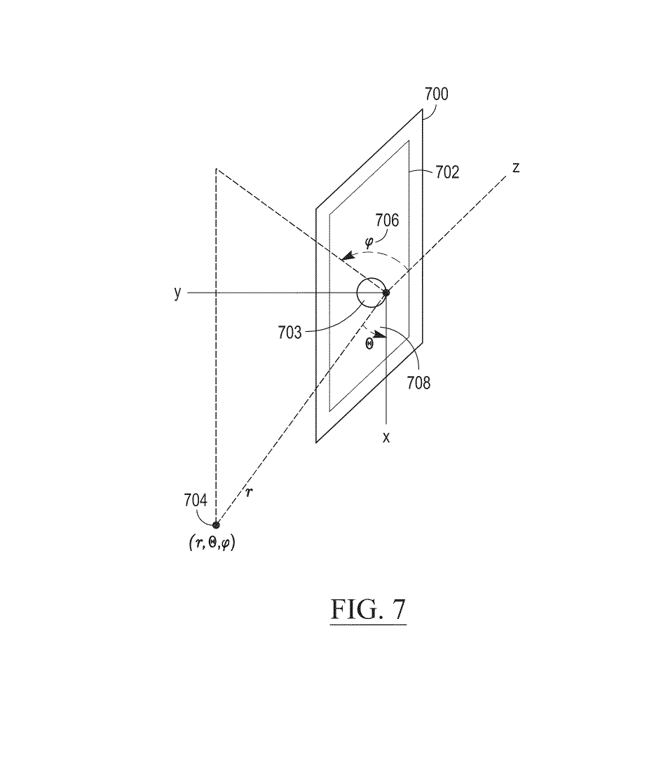

FIG. 7 illustrates an example of controlling presentation of multimedia content by moving a display housing orientation of a multimedia presenting system (e.g. a swivel joint mounted on a multimedia presenting system) and by resizing the image displayed by the multimedia presenting system 700. In this example, as illustrated, the multimedia presenting system 700 includes a display 702, which, as shown, may be mounted by support structure equipped with motorized swivel at a mount point 703 center to the multimedia presenting system 700, or by any other suitable structure generally known in the art operative to support a display using a mount. In this example, the display perspective adjustment logic 106 receives information 200 indicating a position of a user 704 relative to the multimedia presenting system 700. In this example, the user location information 200 received by the display perspective adjustment logic 106 includes information indicating the x, y and z coordinates with respect to the center 703 of the multimedia presenting system 700. Based on the user location information 200, the display perspective adjustment logic 106 determines an angle φ, i.e. an anzimuthal angle, between the user 704 and the center point 703. The display perspective adjustment logic 106 may also determine an angle θ, i.e. a polar angle indicating a degree of inclination, between the user 704 and the center point 703. Further, the display perspective adjustment logic 106 may determine a distance r between 704 and the center point 703 of the multimedia presenting system 700. These determinations may be described using the following formulas:

r=square root (x²+y²+z²);

φ=arctan(y/x);

θ=arctan(z/r);

wherein x, y, z are coordinates of the user 704 location with respect to the center point 703 in a Cartesian coordinate system with the center point 703 as the origin.

Based on the determined relative position between the user 704 and the multimedia presenting system 700, the display perspective adjustment logic 106 can determine an amount of display perspective adjustment. In this example, the information 202 indicates that the multimedia presenting system is capable of repositioning the screen location of the display 702, scaling the image displayed on display 702 to several different resolutions, and rotating the swivel joint at the mount point 703 for certain degrees horizontally or vertically. In this example, the display perspective logic 106 also receives configuration information 206 that configures the display perspective adjustment logic 106. The configuration information 206 in this example configures the multimedia presenting system 700 to change a display perspective of the multimedia presenting system 700 by moving the housing orientation of the multimedia presenting system 700 and changing the resolution of the image o displayed by the multimedia presenting system 700, but not other ways (e.g. ignore changing screen location on display 702 even though the multimedia presenting system 700 indicates it can change screen location of the display 702).

The display perspective adjustment logic 106 may also receive information 202 regarding the visual presentations system 700. In this example, the information 202 indicates that the multimedia presenting system 700 is capable of rotating the display 702 to a range of positions such that the rotation of the display 702 by φ degrees horizontally and θ degrees vertically can be achieved. The information 202 in this example also indicates that the multimedia presenting system 700 can upscale the image displayed on the display 702 to a maximum resolution that is supported by the display 702. Further, the information 202 also indicates that the current display perspective of the multimedia presenting system 700 is such that the display 702 is placed level to the Z-X panel with respect to the center point 703, as illustrated.

Accordingly, based on the relative position between the user 704 and the multimedia presenting system 700, the information 202 regarding the multimedia presenting system 700, the configuration information 206, the display perspective adjustment logic 106 determines to change the display perspective of the multimedia presenting system 700 by upscaling the image video displayed on the display 702 to the maximum resolution supported by the display 702. The display perspective logic 106 also determines that in order for the user 704 to have an optimal viewing experience, the multimedia presenting system 700 needs to tilt down the display 702 (i.e. rotate vertically) at the center point 703 by a number of degrees equivalent to θ and rotate horizontally by a number of degrees equivalent to φ.

Accordingly, based on the determinations made above, the display perspective adjustment logic 106 issues a first control command that instructs the multimedia presenting system 700 to rotate the display 702 by φ degrees horizontally, a second control command that instructs the multimedia presenting system 700 to rotate the display 702 by θ degrees vertically, and a third control command that instructs the multimedia presenting system 700 to upscale the image and/or video displayed on display 700 to the maximum resolution the display 702 is capable of displaying.

FIG. 8 illustrates an example of controlling presentation of multimedia content by changing the placement of a projection screen (e.g. the projection screen 802) based on a detection of an eye level of a user (e.g. the eye level 804 as illustrated) with respect to a multimedia presenting system (e.g. the multimedia presenting system 800). In this example, the apparatus 100 employs a plurality of location detection devices 120, e.g. cameras. The location detection devices 120 in this example monitor a space where the projection screen 802 is located. The location detection device 120 may be, for example, operative to take still images at any desired frequency and/or to take video of the covered space continuously. It is understood the type and number of cameras 120 employed by the apparatus 100 may be varied in other examples. The location detection devices 120 may be bi-directionally and operatively coupled to the processor 102 via wired, wireless connection, or any other suitable connection as generally known in the art. The apparatus 100 in this example further includes a multimedia presenting system 800 having a projector 806. The multimedia presenting system 800 is also operatively connected to the processor 102. The projector 806 in this example projects an image (still and/or video) of the multimedia content onto a screen 802.

In this example, one or more location detection devices 120 take still images of the space where the projection screen 802 is located and send the still images to the processor 102 at a desired frequency either requested by the processor 102 or configured at a configuration stage. The processor 102, in this example, employs location analysis logic 801 to analyze the images received from the location detection devices 120. The location analysis logic 801 referred to herein is any suitable executing software module, hardware, executing firmware or any suitable combination thereof that can perform the desired function, such as programmed processors, discrete logic, for example, state machine, to name a few. It is understood that location analysis logic 801 may be included in the processor 102 as part of the processor 102, or a discrete component of the apparatus 100 that can be executed by the processor 102, such as software programs stored on computer readable storage medium that can be loaded into the apparatus 100 and executed by the processor 102. It is further understood that although the location analysis logic 801 is illustrated to reside on the processor 102 in this example, the location analysis logic 801 may reside on a different discrete processor from 102 and communicate with the processor 102 via a point-to-point connection or system bus.

The location analysis logic 801 in this example compiles the still images taken by the one or more location detection devices 120 and detects that a user 806 is present in the images. The location analysis logic 801 may then determine the location of the user 806 through an image analysis as generally known in the art. The location analysis logic 801 in this example is also operative to detect an eye level 804 of the user 806, i.e. the level of user's 806 eyes is focusing on, by performing any suitable facial recognition analysis as generally known in the art. In addition, optionally, the location analysis logic 801 may also be operative to detect the location of the projection screen 802 by performing any suitable image analysis as generally known in the art. The location analysis logic 801 may communicate the user location information 200, i.e. the user's eye level, the user's location and/or the location of the multimedia presenting system, to the display perspective adjustment logic 106 via either a point-to-point connection, system bus or the system memory of the apparatus 100.

The display perspective adjustment logic 106 receives location information 200 from the location analysis logic 801 in this example. The display perspective adjustment logic 106 may also receive the information 202 regarding the multimedia presenting system 800. In this example, based on the received location information 200 and the information 202, the display perspective adjustment logic 106 determines that the user's eye level 804 is below the projection screen 802. Accordingly, the display perspective adjustment logic 106 determines that projection screen 802 needs to be lowered to the level that matches the user eye level 804. The display perspective adjustment logic 106 then issues a control command to instruct the multimedia presenting system 800 to lower the projection screen 802 to the level of the user's eye level 804. This control command is communicated to the multimedia presenting system 800 either through internal communication means, such as but not limited to, point-to-point connection, system bus, system memory, or through wired or wireless connection between the processor 102 and multimedia presenting system 800. The multimedia presenting system 800, after receives the control command, executes the control command to change the display perspective by lowering the projection screen 802 to the level 804.

Among other advantages, for example, the method and apparatus provides the ability to change a display perspective of multimedia presenting system based on a user's position relative to the multimedia presenting system without requiring the user's intervention. Instead of having the user determine such a relative position, determine an amount of display perspective adjustment based on such a relative position, and manually perform the display perspective adjustment as the user's location changes with respect to the multimedia presenting system, the method and apparatus performs all of above automatically. Furthermore, the method and apparatus can intelligently determine an amount of display perspective adjustment based on the capability, status, and position of the multimedia presenting system. Accordingly, the proposed method and apparatus can improve user viewing experience of multimedia content presented by the multimedia presenting system by providing an automatic adjustment of a display perspective of the multimedia presenting system as the user's location changes. Other advantages will be recognized by those of ordinary skill in the art.

The above detailed description of the disclosure and the examples described therein have been presented for the purpose of illustration and description only and not by limitation. It is therefore contemplated that the present invention cover any and all modifications, variations, or equivalents that fall within the spirit and scope of the basic underlying principles disclosed above and claimed herein.

What is claimed is:

1. A method, carried out by one or more apparatus, for controlling presentation of multimedia content comprising:
changing a display perspective of a multimedia presenting system based on data indicating a relative position between a user and the multimedia presenting system.

2. A method, carried out by one or more apparatus, for controlling presentation of multimedia content comprising:
determining a relative position between a user and a multimedia presenting system; and
changing a display perspective of the multimedia presenting system based on the determined relative position between the user and the multimedia presenting system.

3. The method of claim 2, wherein changing the display perspective of the multimedia presenting system comprises:
determining an amount of display perspective adjustment based on the determined relative position between the user and the multimedia presenting system; and
issuing at least one control command according to the determined amount of display perspective adjustment;

4. The method of claim 2, wherein changing the display perspective of the multimedia presenting system is based on at least one of the followings:
a determination of at least one capability of the multimedia presenting system;
a determination of a status of the multimedia presenting system;
a determination of a current display perspective of the multimedia presenting system; and
configuration information for changing a display perspective of the multimedia presenting system.

5. The method of claim 4, wherein the determinations are made by obtaining information regarding the multimedia presenting system through at least one of the followings:
a query operation to receive the information regarding the multimedia presenting system from the multimedia presenting system;
a push operation performed by the multimedia presenting system, wherein the push operation sends the information regarding the multimedia presenting system; and
a look-up operation to obtain the information regarding the multimedia presenting system stored in memory storage.

6. The method of claim 2, wherein changing the display perspective of the multimedia presenting system comprises at least one of:
moving a display housing orientation of the multimedia presenting system;
adjusting the size and/or resolution of visual content displayed by the multimedia presenting system; and
adjusting placement of visual content displayed by the multimedia presenting system.

7. The method of claim 2, wherein determining the relative position between the user and the multimedia presenting system comprises obtaining the user's location information from at least one location detection device.

8. The method of claim 2, wherein determining the relative position between the user and the multimedia presenting system further comprises:
obtaining the information indicating the user's location and/or the location of the multimedia presenting system from at least one remote source; and
determining the relative position between the user and the multimedia presenting system by comparing the user's location to the location of the multimedia presenting system based on the obtained information indicating the user's location and/or the location of the multimedia presenting system.

9. The method of claim 2, wherein changing the display perspective of the multimedia presenting system comprises:
detecting an eye level of the user with respect to the multimedia presenting system; and
changing the display perspective of the multimedia presenting system to match the detected eye level of the user.

10. The method of claim 2 further comprising changing audio output properties of the multimedia presenting system base on the determined relative position between the user and the multimedia presenting system.

11. The method of claim 10, wherein changing audio output properties comprises adjusting audio volume of the multimedia presenting system.

12. An apparatus for controlling presentation of multimedia content comprising:
display perspective adjustment logic operative to:
change a display perspective of a multimedia presenting system based on data indicating a relative position between a user and the multimedia presenting system.

13. An apparatus for controlling presentation of multimedia content comprising:
display perspective adjustment logic operative to:
determine a relative position between a user and a multimedia presenting system; and
change a display perspective of the multimedia presenting system based on the determined relative position between the user and the multimedia presenting system.

14. The apparatus of claim 13, wherein changing the display perspective of the multimedia presenting system comprises:
determining an amount of display perspective adjustment based on the determined relative position between the user and the multimedia presenting system; and
issuing at least one control command to change the display perspective of the multimedia presenting system according to the determined the amount of display perspective adjustment.

15. The apparatus of claim 13, wherein change a display perspective of the multimedia presenting system is based on at least one of the followings:
a determination of at least one capability of the multimedia presenting system;
a determination of a status of the multimedia presenting system;
a determination of a current display perspective of the multimedia presenting system; and
configuration information for changing a display perspective of the multimedia presenting system.

16. The apparatus of claim 13, wherein changing the display perspective of the multimedia presenting system comprises at least one of:
moving a display housing orientation of the multimedia presenting system;
adjusting the size and/or resolution of visual content displayed by the multimedia presenting system; and
adjusting placement of visual content displayed by the multimedia presenting system;

17. The apparatus of claim 13 further comprising at least one location detection device operative to obtain the user location information.

18. The apparatus of claim 13, wherein determining a relative position between a user and a multimedia presenting system comprises:
obtaining the information indicating the user's location and/or the location of the multimedia presenting system from at least one remote source; and
determining the relative position between the user and the multimedia presenting system by comparing the user's location to the location of the multimedia presenting system based on the obtained information indicating the user's location and/or the location of the multimedia presenting system.

19. The apparatus of claim 13, wherein changing the display perspective of the multimedia presenting system comprises:
detecting an eye level of the user with respect to the multimedia presenting system; and
changing the display perspective of the multimedia presenting system to match the detected eye level of the user with respect to the multimedia presenting system.

20. The apparatus of claim 12, wherein the display perspective adjustment logic is further operative to change audio output properties of the multimedia presenting system base on the determined relative position between the user and the multimedia presenting system.

21. The apparatus of claim 20, wherein changing audio output properties comprises adjusting audio volume of the multimedia presenting system.

22. An apparatus for controlling presentation of multimedia content comprising:
a multimedia presenting system operative to present multimedia content;
at least one location detection device operative to detect a location of a user and/or the multimedia presenting system; and
display perspective adjustment logic operative to:
change a display perspective of the multimedia presenting system based on data indicating a relative position between a user and the multimedia presenting system.

23. A non-transitory computer readable storage medium comprising executable instructions that when executed by one or more processors cause the one or more processors to:
change a display of a multimedia presenting system based on data indicating a relative position between a user and the multimedia presenting system.

24. A non-transitory computer readable storage medium comprising executable instructions that when executed by one or more processors cause the one or more processors to:
determine a relative position between a user and a multimedia presenting system; and
change a display of the multimedia presenting system based on the determined relative position between the user and the multimedia presenting system.

25. The non-transitory computer readable storage medium of claim 24, wherein changing the display perspective of the multimedia presenting system comprises:
determining an amount of display perspective adjustment based on the determined relative position between the user and the multimedia presenting system; and
issuing at least one control command according to the determined amount of display perspective adjustment.

26. The non-transitory computer readable storage medium of claim 25, wherein determining the amount of display perspective adjustment for the multimedia presenting system is based on at least one of the followings:
a determination of at least one capability of the multimedia presenting system;
a determination of a status of the multimedia presenting system; and
a determination of a current display perspective of the multimedia presenting system.

27. The non-transitory computer readable storage medium of claim 24, wherein changing the display perspective of the multimedia presenting system comprises at least one of:
moving a display housing orientation of the multimedia presenting system;
adjusting a size and resolution of visual content displayed by the multimedia presenting system; and
adjusting placement of image and/or video displayed by the multimedia presenting system.

28. The non-transitory computer readable storage medium of claim 24, wherein determining a relative position between a user and a multimedia presenting system comprises:
obtaining the information indicating the user's location and/or the location of the multimedia presenting system from at least one remote source; and
determining the relative position between the user and the multimedia presenting system by comparing the user's location to the location of the multimedia presenting system based on the obtained information indicating the user's location and/or the location of the multimedia presenting system.

29. The non-transitory computer readable storage medium of claim 24, wherein changing the display perspective of the multimedia presenting system comprises:
detecting an eye level of the user with respect to the multimedia presenting system; and
changing the display perspective of the multimedia presenting system to match the detected eye level of the user with respect to the multimedia presenting system.

30. The non-transitory computer readable storage medium of claim 24, wherein the display perspective adjustment logic is further operative to change audio output properties of the multimedia presenting system base on the determined relative position between the user and the multimedia presenting system.
